(19) United States
(12) Patent Application Publication
(10) Pub. No.: US 2007/0005826 A1
(43) Pub. Date: Jan. 4, 2007

(54) Termination control in memory systems

(76) Inventors: Hsien-Pao Yang, Folsom, CA (US); Kuljit S. Bains, Olympia, WA (US); Ron A. Starbuck JR., Sacramento, CA (US)

Correspondence Address: LeMOINE PATENT SERVICES, PLLC, C/O INTELLEVATE, P. O. BOX 52050, MINNEAPOLIS, MN, 55402, US

(21) Appl. No.: 11/171,624

(22) Filed: Jun. 30, 2005

(51) Int. Cl. G06F 13/28

(52) U.S. Cl. 710/24

(57) ABSTRACT

A memory controller includes controllable on-die terminations that may be turned on and off separately.

### FIELD

The present invention relates generally to memory systems, and more specifically to on-die-terminations in memory systems.

### BACKGROUND

Modern computer systems use memory controllers to communicate with memory devices. Typically, one memory controller is coupled to multiple memory devices, or “chips,” and the memory controller manages data transfers to and from the memory devices on behalf of other devices in the computer system. Data transfer rates between memory controllers and memory devices continue to increase.

### BRIEF DESCRIPTION OF THE DRAWINGS

FIG. 1 shows a diagram of a memory controller;

FIG. 2 shows a diagram of a memory controller and memory devices;

FIG. 3 shows an exchange of commands and data between a memory controller and memory devices;

FIG. 4 shows a flowchart in accordance with various embodiments of the present invention; and

FIG. 5 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

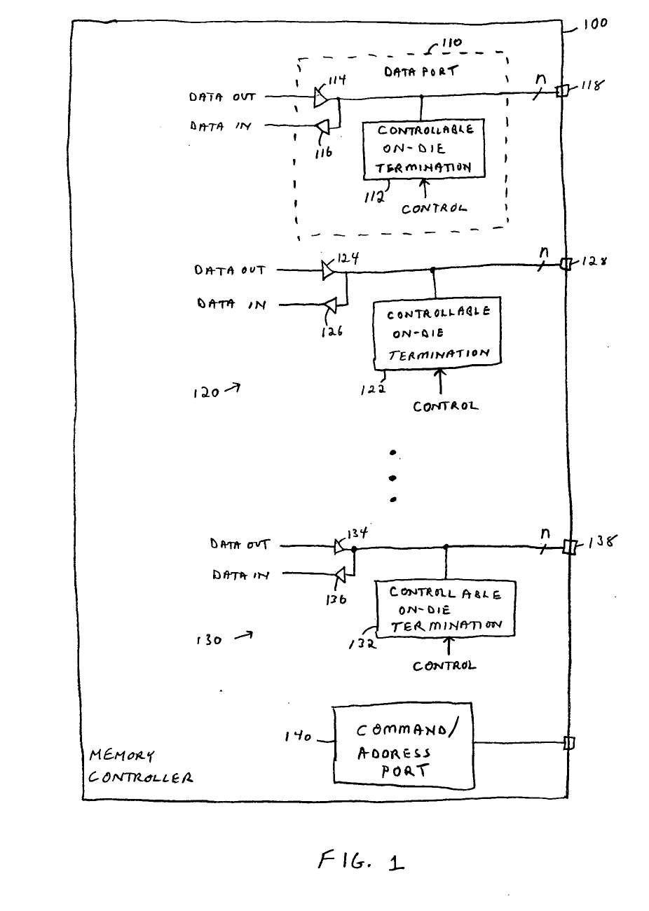

FIG. 1 shows a diagram of a memory controller. Memory controller 100 includes data ports 110, 120, 130, and command/address port 140. Data port 110 is shown having driver 114, receiver 116, and controllable on-die termination 112. In some embodiments, data port 110 may include “n” drivers 114 and “n” receivers 116, and controllable on-die termination 112 may provide “n” terminations. Accordingly, data port 110 is shown having “n” signal lines coupled to signal interconnect 118 at the boundary of memory controller 100. As shown in FIG. 1, “n” may be any number, and the circuitry shown in data port 110 may be replicated any number of times such that “n” separate data signals can be transmitted and received via data port 110 through signal interconnect 118.

Data port 120 is shown including driver 124, receiver 126, and controllable-on-die termination 122, and data port 130 is shown including driver 134, receiver 136, and controllable-on-die termination 132. Like data port 110, the circuitry of data ports 120 and 130 may be replicated “n” times to support an “n” bit wide communications path.

Each of data ports 110, 120, and 130 provide a bidirectional data communications capability to memory devices external to memory controller 100. For example, in some embodiments, each of signal interconnects 118, 128, and 138 are coupled to a separate memory device. Further, in some embodiments, command/address port 140 provides commands and addresses to the memory devices in parallel.

In some embodiments, memory controller 100 may be used in a memory system that operates as a dual data rate (DDR) system. For example, data read cycles may occur in bursts in response to read commands and addresses provided by command/address port 140, and data write cycles may also occur in bursts when write commands are provided by command/address port 140.

Each of data ports 110, 120, and 130 include a controllable on-die termination network to conditionally terminate the signal lines connected to signal interconnects 118, 128, and 138. In some embodiments, the controllable on-die terminations may be turned on and off. For example, when controllable on-die terminations are turned on, a termination is provided on the signal lines, and when turned off, no termination is present.

Controllable on-die terminations may provide a termination to terminate signals during a read cycle when data is provided by memory devices to one of data ports 110, 120, or 130. Controllable on-die terminations are turned off when data is driven from memory controller 100 to memory devices (not shown) coupled to signal interconnects 118, 128, and 138.

The combination of signal interconnects 118, 128, and 138 forms a segmented data bus where each segment includes a separate controllable on-die termination network within the memory controller. Each of the data bus segments in FIG. 1 is shown having a width of “n.” In some embodiments, “n” may be equal to eight, and in other embodiments, “n” may be equal to 16. Further, in some embodiments, “n” may be equal to 32. The various embodiments of the present invention are not limited by the width of each data bus segment.

Memory controller 100 is shown in FIG. 1 having three data ports. In some embodiments, more than three data ports are included. For example, in some embodiments, a data bus may be 64 bits wide with eight segments of eight bits each. In these embodiments, memory controller may include eight data ports with “n” being equal to eight.

In some embodiments, memory controller 100 may include many more functional blocks and circuits than are shown in FIG. 1. For example, memory controller 100 may include a microcontroller and an interface to other external devices such as microprocessors and other peripheral devices. Only a portion of memory controller 100 is shown in FIG. 1, and the various memory controller embodiments of the invention are not limited to the blocks shown in FIG. 1.

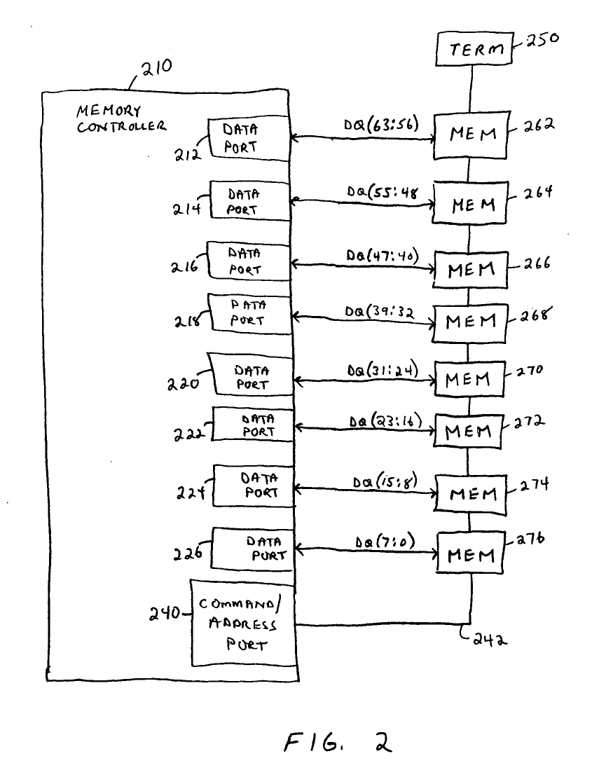

FIG. 2 shows a diagram of a memory controller and memory devices. Memory controller 210 includes data ports 212, 214, 216, 218, 220, 222, 224, and 226. Memory controller 210 also includes command/address port 240. Also shown in FIG. 2 are memory devices 262, 264, 266, 268, 270, 272, 274, and 276. Also shown in FIG. 2 is termination network 250.

Each of the memory devices shown in FIG. 2 is coupled to a corresponding data port within memory controller 210. For example, memory device 262 is coupled to data port 212 by an eight bit wide data bus segment labeled DQ(63:56). Accordingly, each of the memory devices shown in FIG. 2 are eight bit wide memory devices, although this is not a limitation of the present invention. For example, in some embodiments, the memory devices may be eight bits wide, 16 bits wide, 32 bits wide, or any other width.

Each of the memory devices shown in FIG. 2 is also coupled to command/address port 240 within memory controller 210. Command/address port 240 drives commands and addresses on bus 242, which is coupled to the various memory devices in a daisy chain fashion, and is terminated at the end of the daisy chain at termination network 250. Bus 242 may include a command bus, and address bus, and various control signals. The particular configuration of bus 242 is not a limitation of the present invention.

In operation, memory controller 210 may issue a read command on bus 242, and that command is received by each of the memory devices staggered in time, in part because of a propagation delay (and associated signal transit time) along the length of bus 242. In response to the read command, each memory device provides eight bits of data to its corresponding data port within memory controller 210. Each data port may receive data from the corresponding memory device at a different time, in part because of the propagation delay of commands and addresses on bus 242, and also in part because the routing of data signal traces between the various memory devices and memory controller 210 may be different.

Each of the data ports within memory controller 210 includes the ability to separately control an on-die termination corresponding to the eight bits of data received from the corresponding memory device. Those data ports that receive data early may turn off the on-die termination early, and perform other operations earlier than they would otherwise be capable. For example, a data port may receive data earlier than others and turn off an associated on-die termination. The memory controller may issue a write command, and that data port may then drive write data on its bus segment while other data ports are still completing the previous read cycle.

Those data ports receiving data later in a read cycle may leave the controllable on-die terminations turned on until the data is received, and then the controllable on-die terminations may be turned off. By turning off controllable on-die terminations as soon as data is received, a memory controller may be capable of performing subsequent operations on some data ports while other data ports are still receiving data from the read cycle.

The preceding paragraphs describe the operation of memory controller 210 in the context of a read command followed by a write command, but this is not a limitation of the present invention. In general, any type of command may follow any other type of command while separately controlling on-die terminations. For example, a read command may be followed by another read command, and a write command may be followed by a read command or another write command.

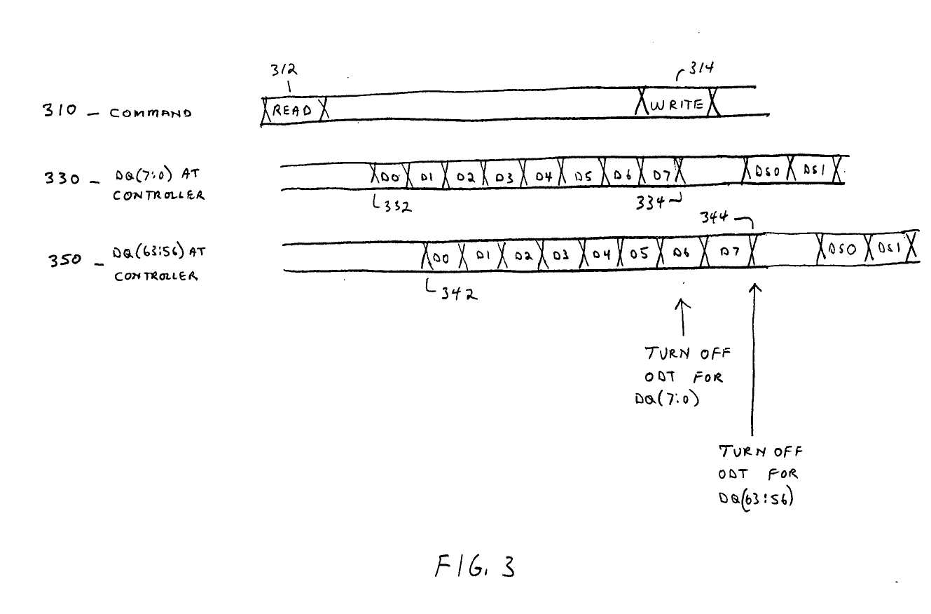

FIG. 3 shows an exchange of commands and data between a memory controller and memory devices. Commands issued by a memory controller are shown generally at 310, data received from and sent to a first memory device is shown generally at 330, and data sent to and received from a second memory device is shown generally at 350. For example, the commands shown at 310 may be commands driven on a command bus such as command bus 242 (FIG. 2). Also for example, data shown at 330 may correspond to data provided to and from memory device 276 (FIG. 2), and data shown generally at 350 may correspond to data sent to and received from memory device 262 (FIG. 2).

In some embodiments, the interface between the memory controller and the memory devices is a synchronous interface that includes one or more clock signals (not shown). For example, a command bus driven by the memory controller may include a clock signal that is received at the various memory devices staggered in time.

At 312, the memory controller issues a read command, and that read command is received staggered in time at memory devices in part because of the signal transmit time of the daisy chained command bus. Memory devices respond to the read command by transferring data shown in FIG. 3 as D0-D7. At 330, data from the first memory device begins to arrive at the controller at time 332, and as shown at 350, data from the second memory device begins to arrive at the controller at time 342.

As shown in FIG. 3, data is received from various memory devices staggered in time in part because the read command is received at the memories staggered in time, and also in part because of differences in interconnect delays in the data bus segments between memory devices and the memory controller. As shown at 330, the last data word from the first memory device is received at the controller at time 334. At this time, the memory controller may turn off the controllable on-die terminations (ODT) for the segment of the data bus corresponding to the memory device driving that particular segment. As shown at 350, the last data word from the second memory device is received at time 344, and the memory controller can turn off the controllable on-die termination corresponding to the memory device driving that particular segment of the data bus.

Because the memory controller is able to turn off on-die terminations separately for the various segments of the data bus, those segments that complete the read cycle first may also begin a write cycle first. For example, a write command shown at 314 may be issued earlier than it would otherwise be able, thereby allowing a write to occur at the first memory device as soon as possible after the read has been completed. In some embodiments, the write data shown as DS0-DS1 may be driven on the data lines to the first memory device (shown at 330) before the read of the second device has been completed (shown at 350).

The diagrams in FIG. 3 describe the operation of controllable on-die terminations in the context of a read command followed by a write command, but this is not a limitation of the present invention. In general, any type of command may follow any other type of command while separately controlling on-die terminations. For example, a read command may be followed by another read command, and a write command may be followed by a read command or another write command.

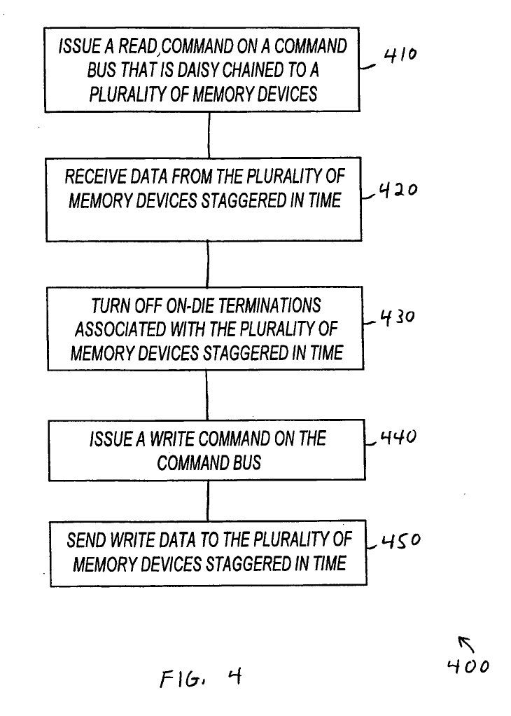

FIG. 4 shows a flowchart in accordance with various embodiments of the present invention. In some embodiments, method 400 may be used to operate controllable on-die terminations. In some embodiments, method 400, or portions thereof, is performed by a memory controller, a memory system, or an electronic system, embodiments of which are shown in the various figures. Method 400 is not limited by the particular type of apparatus, software element, or system performing the method. The various actions in method 400 may be performed in the order presented, or may be performed in a different order. Further, in some embodiments, some actions listed in FIG. 4 are omitted from method 400.

Method 400 is shown beginning at block 410 in which a read command is issued on a command bus that is daisy chained to a plurality of memory devices. For example, a command bus such as command bus 242 (FIG. 2) may be daisy chained to a plurality of memory devices, and a memory controller such as memory controller 210 (FIG. 2) may issue a read command. The read command may be a read command such as that shown at 312 in FIG. 3. At 420, data is received from the plurality of memory devices staggered in time. For example, as shown in FIG. 3, data shown at 330 and 350 arrives at the memory controller staggered in time due in part to the propagation delay along the command bus as well as routing differences in the data bus segments between the memory controller and the memory devices.

At 430, on-die terminations associated with the plurality of memory devices are turned off staggered in time. The on-die terminations may be turned off as the read cycles are completed for the various memory devices. For example, as shown in FIG. 3, the on-die terminations for DQ(7:0) may be turned off at 334, and the on-die terminations for DQ(63:56) may be turned off at time 344.

At 440, a write command is issued on the command bus. The write command may be issued prior to the last data arriving at the controller or prior to the on-die termination being turned off. For example, in synchronous devices, a write command may be issued multiple clock cycles prior to the time at which data is sourced to the memory device. At 450, write data is sent to the plurality of memory devices staggered in time. In some embodiments, the write data is staggered in such a way that the memory devices will receive the data at the appropriate time when the propagation delays are taken into effect. For example, the propagation delay of the command bus and the propagation delay of the various data bus segments may be taken into account when determining when to source write data on the various bus segments.

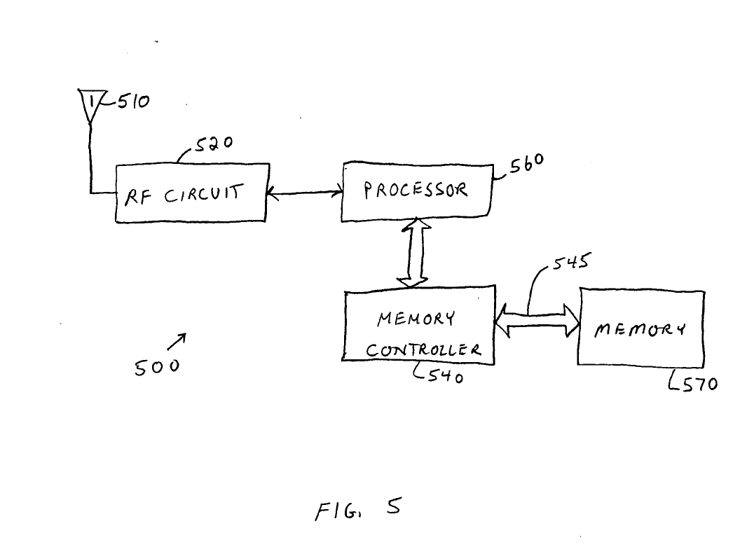

FIG. 5 shows a system diagram in accordance with various embodiments of the present invention. Electronic system 500 includes antenna 510, radio frequency (RF) circuit 520, processor 560, memory controller 540, and memory 570. In some embodiments, electronic system 500 may be a system with a memory system having controllable on-die terminations associated with separate data bus segments in a segmented bus. Also for example, electronic system 500 may include a memory system capable of performing any of the methods described with reference to the previous figures.

In some embodiments, electronic system 500 may represent a system that includes the circuits shown in FIG. 5 as well as other circuits. For example, in some embodiments, electronic system 500 may be a computer, such as a personal computer, a workstation, or the like, that includes a memory system. Further, electronic system 500 may be a cellular phone, personal digital assistant (PDA), or camera. Further, electronic system 500 may represent a node in a wireless network, such as a mobile station or an access point.

Antenna 510 may be a directional antenna or an omni-directional antenna. As used herein, the term omni-directional antenna refers to any antenna having a substantially uniform pattern in at least one plane. For example, in some embodiments, antenna 510 may be an omni-directional antenna such as a dipole antenna, or a quarter wave antenna. Also for example, in some embodiments, antenna 510 may be a directional antenna such as a parabolic dish antenna or a Yagi antenna. In still further embodiments, antenna 510 includes multiple physical antennas. For example, in some embodiments, multiple antennas are utilized to multiple-input-multiple-output (MIMO) processing or spatial-division multiple access (SDMA) processing.

In operation, system 500 sends and receives signals using antenna 510, and the signals are processed by the various elements shown in FIG. 5. Radio frequency circuit 520 is coupled to antenna 510 to interact with other wireless devices. RF circuit 520 may include circuitry to support the transmission and reception of radio frequency (RF) signals. For example, in some embodiments, RF circuit 520 includes an RF receiver to receive signals and perform “front end” processing such as low noise amplification (LNA), filtering, frequency conversion or the like. Also for example, in some embodiments, RF circuit 520 may include circuits to support frequency up-conversion, and an RF transmitter. The invention is not limited by the contents or function of RF circuit 520.

RF circuit 520 may also provide a physical layer (PHY) implementation suitable for use in a wireless network. For example, RF circuit 520 may implement a physical layer that complies with an IEEE 802.11 standard or other standard. Examples include, but are not limited to, direct sequence spread spectrum (DSSS), frequency hopping spread spectrum (FHSS), and orthogonal frequency division multiplexing (OFDM).

Processor 560 may perform method embodiments of the present invention, or may program memory controller 540 to perform method embodiments of the present invention, such as method 400 (FIG. 4). Processor 560 represents any type of processor, including but not limited to, a microprocessor, a digital signal processor, a microcontroller, or the like.

Memory controller 540 is a memory controller with separately controllable on-die terminations. For example, memory controller 540 may be memory controller 100 (FIG. 1) or memory controller 210 (FIG. 2). Memory controller 540 provides an interface between memory 570 and other elements within electronic system 500.

Memory 570 represents a plurality of memory devices that are coupled to memory controller 540. In some embodiments, memory 570 includes multiple memory devices that are coupled to a command/address bus as shown in FIG. 2. Also in some embodiments, memory 570 represents a plurality of memory devices that are coupled to separate data bus segments of a data bus coupled to memory controller 540. Bus 545 is shown coupling memory controller 540 to memory 570. In some embodiments, bus 545 includes multiple data segments such as those shown in FIG. 2. Further, in some embodiments, bus 545 may includes a command/address bus coupled to memory devices in memory 570 in a daisy chain fashion.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
issuing a read command on a command bus that is daisy chained to a plurality of memory devices;
receiving data from the plurality of memory devices staggered in time; and
turning off on-die terminations associated with the plurality of memory devices staggered in time.

2. The method of claim 1 further comprising:
issuing a write command on the command bus; and
sending write data to the plurality of memory devices staggered in time.

3. The method of claim 2 further comprising:
turning on the on-die terminations staggered in time; and
issuing a second read command.

4. The method of claim 2 further comprising issuing a second write command.

5. The method of claim 1 further comprising:
turning on the on-die terminations staggered in time; and
issuing a second read command.

6. The method of claim 1 wherein turning off on-die terminations comprises turning off on-die terminations based on arrival times for data from the plurality of memory devices.

7. The method of claim 6 wherein turning off on-die terminations staggered in time comprises turning off the on-die terminations based at least in part on a signal transit time on the command bus.

8. The method of claim 7 wherein turning off on-die terminations staggered in time further comprises turning off the on-die terminations based at least part on data signal trace lengths between the memory devices and a device performing the method.

9. A memory controller comprising:
a command/address port to couple to a plurality of memory devices in a daisy chain fashion; and
a plurality of data ports, wherein each of the plurality of data ports includes a separately controllable on-die termination to be coupled to a separate memory device.

10. The memory controller of claim 9 wherein each of the plurality of data ports is eight bits wide.

11. The memory controller of claim 9 wherein each of the plurality of data ports is 32 bits wide.

12. The memory controller of claim 9 wherein the memory controller can drive write data on the plurality of data ports staggered in time.

13. The memory controller of claim 9 wherein each of the separately controllable on-die terminations is to be turned off after receiving data from a memory device to which it is coupled.

14. A memory controller comprising:
a segmented data bus that includes a plurality of segments; and
a separately controllable on-die termination for each of the plurality of segments.

15. The memory controller of claim 14 wherein each of the plurality of segments includes eight bits.

16. The memory controller of claim 14 wherein each of the plurality of segments includes 32 bits.

17. The memory controller of claim 14 wherein a turn-off time for each of the separately controllable on-die terminations is based on arrival times of data.

18. The memory controller of claim 14 further comprising a command/address port to couple to a plurality of memory devices in a daisy chain fashion.

19. The memory controller of claim 18 wherein each of the plurality of segments is to be coupled to a corresponding one of the plurality of memory devices.

20. An electronic system comprising:
an antenna;
a radio frequency circuit coupled to the antenna;
a processor coupled to the radio frequency circuit; and
a memory controller coupled to the processor, the memory controller including a segmented data bus that includes a plurality of segments, and a separately controllable on-die termination for each of the plurality of segments.

21. The electronic system of claim 20 further comprising a plurality of memory devices, wherein each of the plurality of memory devices is coupled to a corresponding one of the plurality of segments.

22. The electronic system of claim 21 wherein the memory controller includes a command/address port to couple to the plurality of memory devices in a daisy chain fashion.

23. The electronic system of claim 21 wherein a turn-off time for each of the separately controllable on-die terminations is based on arrival times of data from the plurality of memory devices.
